(19) United States
(12) Patent Application Publication
(10) Pub. No.: US 2025/0042795 A1
(43) Pub. Date: Feb. 6, 2025

(54) METHOD FOR PURIFYING WATER CONTAINING ORGANIC IMPURITIES BY ULTRAFILTRATION

(71) Applicant: Dmitrii V. Tateosov, Odintsovo (RU)

(72) Inventor: Dmitrii V. Tateosov, Odintsovo (RU)

(21) Appl. No.: 18/685,429

(22) PCT Filed: Oct. 3, 2022
(86) PCT No.: PCT/RU2022/000299

§ 371 Date: Feb. 21, 2024

(30) Foreign Application Priority Data
Apr. 18, 2022 (RU) 2022110402

(51) Int. Cl. C02F 9/00; B01D 61/14; B01D 61/16; B01D 61/18; B01D 71/02; C02F 1/44; C02F 1/66; C02F 1/78

(52) U.S. Cl. CPC C02F 9/00; B01D 61/145; B01D 61/16; B01D 61/18; B01D 71/024; B01D 2311/02; C02F 1/444; C02F 1/66; C02F 1/78; C02F 2301/024; C02F 2301/046; C02F 2303/04

(57) ABSTRACT

The invention relates to the field of water purification, namely to methods and devices for water purification using the ultrafiltration method and is intended primarily for purifying water with organic contaminants. The method of purifying water with organic impurities by ultrafiltration consists of preliminary preparation of water for ultrafiltration, which consists of ozonation and mixing by recirculation in a contact container, as well as in the process of ultrafiltration itself utilizing membranes. In the near-membrane space of the ultrafiltration device there is formed a high-speed gas-liquid regime with a water-bubble flow flowing around the membrane surface. Wherein, water supplied to the ultrafiltration device is carried out simultaneously with the supply of ozone-air or ozone-oxygen mixture through at least one water-jet ejector. A second recirculation cycle is organized through the ultrafiltration device into the contact container and again into the ultrafiltration device. In the near-membrane space of the ultrafiltration device there is formed a high-speed gas-liquid regime with a water-bubble flow flowing around the membrane surface. Wherein the water flow through the water-jet ejector is set in the range from 0.5 to 45 m³/h, the ozone mixture flow is in the range from 0.3 to 30 m³/h, and pressure in the ejector discharge line is in the range from 0.2 to 1.6 MPa. The method is carried out using a system including an ozonation device, a contact tank, a recirculation line and an ultrafiltration device itself. At least one water-jet ejector is provided at the inlet to the ultrafiltration device, wherein the working diameter of the suction nozzle relates to the working diameter of the discharge line nozzle in the values between 0.35 and 1.0.

### TECHNICAL FIELD

The invention in general relates to water treatment, and more specifically to methods and devices for cleaning water using the ultrafiltration method and is intended primarily for cleaning water containing organic pollutants.

### PRIOR ART

Currently, there are known many methods and devices for cleaning water for certain target needs to achieve a specified degree of purification. In many instances, this task can be effectively addressed using the method of ultrafiltration.

Often, before ultrafiltration of water and/or at the initial stages of its treatment, it is advisable to simultaneously carry out disinfection and/or decontamination, which in many cases is carried out using ozonation. For example, it is known as a water purification plant, including ultrafiltration devices with membrane ceramic elements, an ozonizer, an ejector and a mixing chamber.

Using these devices, water is purified by supplying water simultaneously with the ozone mixture to the mixing chamber, and then to two successively installed ultrafiltration apparatuses [2]. However, if organic impurities are present in water (and they are almost always found in it), the impurities are oxidized by ozone to form viscous reaction products (mucus) that pollute—envelop the membrane surface, clog pores and reduce filtration efficiency.

The closest prior art known to the inventor and related to the present invention, is a method of purifying water with organic impurities by ultrafiltration disclosed by Russian Patent [symbol] 2668036 to Tateosov. The method consists of a preliminary preparation of water for ultrafiltration, which consists of preliminary purification. For example, this can be carried out on a mesh filter, by ozonation while simultaneously mixing by recirculation in a contact container, as well as in the process of ultrafiltration itself.

This method is implemented in the unit containing a device for preliminary cleaning, a water-jet ejector, a contact tank, and an ultrafiltration device, which are sequentially organized into a single technological chain. The disadvantages of the method and, accordingly, the device for its implementation is the contamination of the membrane surface with oxidation products of organic impurities and, as a result, a decrease in their filtering ability, which leads to the need for additional cleaning measures or restoration of membrane functionality.

### The Problem to be Solved and the Technical Result Achieved by the Invention

The essential goal of the invention is to address drawbacks of the above-mentioned technical solutions and to achieve a technical result in the reduction of surface pollution level of ultrafiltration membranes from organic and organochlorine impurities (organic impurities). This process takes place by oxidation products of organic and organochlorine impurities (organic impurities or organics), which leads to increased efficiency of water purification.

This leads to greater efficiency in cleaning the water and to reducing a number of steps to clean up the membrane. Moreover, the technical result is also considered to be an expansion of the arsenal of technical means for purifying water containing organic impurities using the ultrafiltration method, as well as devices for its implementation.

### Disclosure of the Invention

The specified technical result in the claimed invention is achieved through the implementation of a method for purifying water containing organic impurities by the ultrafiltration method, comprising a preliminary preparation of water for ultrafiltration, consisting of ozonation and mixing by recirculation in a contact container, as well as in the process of ultrafiltration itself utilizing membranes.

According to the method, water is supplied to the ultrafiltration device simultaneously with the supply of ozonated air or ozone-oxygen mixture through at least one water-jet ejector. A second recirculation cycle is organized by passing through the ultrafiltration device into the contact container and again passing into the ultrafiltration device; a high-speed and/or turbulent ultrafiltration device is situated in the near-membrane space of the ultrafiltration device; with a water-bubble flow provided flowing around the membrane surface. This occurs when setting the water flow rate through the water-jet ejector in the range from 0.5 to 45 m3/hour, the flow rate of ozonated air or ozone-oxygen mixture in the range between 0.3 and 30 m³/hour, as well as pressure at the ejector discharge line in the range between 0.2 and 1.6 MPa.

For an unambiguous and more complete understanding of the description of the claimed invention, clarifications and disclosures of the concepts and terms used above, as well as a description of the method, are provided below.

In the method of water purification using ultrafiltration, initially a preliminary preparation is carried out having the main goal to remove coarse mechanical contaminants and to reduce the amount of other contaminants, including homogeneous ones. This allows subsequent ultrafiltration to be carried out with greater efficiency.

Preliminary preparation is carried out, for example, by filtration in the mechanical filters, chemical treatment, oxidation and settling. These techniques can be used in different variations and sequences.

Among such techniques, it should be noted oxidation with ozone accompanied by simultaneous stirring or mixing. This provides the oxidation of organic impurities in water and their transformation into a colloidal viscous (slime-like) state. In such condition the impurities can be separated. In addition, ozonation facilitates disinfection from bacteria and viruses.

According to the inventor's experience, the most effective way of ozonation is to supply the ozone mixture into the volume of water treated by means of a water-jet ejector (ejector).

The water to be treated with ozone is typically located in a contact container. Other known methods of ozonation including simultaneous supply of gas and liquid components or bubbling are less effective, however possible.

Ozonated air or ozone-oxygen mixtures are usually used as ozone mixtures, depending on the degree of water contamination and the applicable volume. In addition, the use of an ejector allows to adjust the direction of the jet, the intensity of the flow, as well as the gas-liquid ratio.

Greater efficiency of ozonation can be achieved by recycling through a contact container according to the following procedure: exiting from the container—entering into to the container. To perform recycling, a pipeline line external to the contact container is provided.

As a result of ozonation of water in a container, organic oxidation products are already formed in the container. However, complete oxidation of organic impurities situated in the water of the contact container is not easy to achieve.

It is understood that in the invention a water-jet ejector is an ejector applicable when implementing a pressure line for injection with/of water, while an ozone gas mixture is supplied through the suction line. The suction line is typically located on the side of the pressure line.

This line is connected to the receiving chamber of the ejector, wherein a vacuum/low pressure zone is created due to the high-speed flow of water from the ejector pressure line. Due to the vacuum, the ozone gas mixture is absorbed and subsequently mixed with water.

Water treated with ozone in a contact tank, together with oxidation products of organic impurities are directed to the ultrafiltration device (ultrafiltration module).

This water enters the inlet compartment (receiving chamber) of the ultrafiltration device through an ejector, which is a device for entering the filtered water into the inlet compartment of the ultrafiltration device.

Simultaneously, the ozone mixture again enters through the suction pipe/branch of the ejector. Preferably, the ejector is adjustable, i.e. having the ability to regulate the pressurized water flow and to regulate the flow of the sucked ozone mixture, as well as the pressure in the receiving chamber.

In some cases, it is possible to provide an ejector with two suction pipes for introducing additional components. For design and technological reasons, water can be introduced into the ultrafiltration device using a group of ejectors. One of the benefits of such an approach is the increased ozonation of water, as well as the increased rate of filtration.

In the receiving chamber of the ultrafiltration device, additional oxidation of organic impurities occurs. This can be facilitated by the turbulent regime of filtered water formed at the outlet of the ejector, which is achieved by increasing the pressure of the discharge flow.

Thus, organic oxidation products formed in the contact tank and in the receiving chamber of the ultrafiltration device accumulate in the receiving chamber. This complicates the filtration process. For this reason, an outlet line is provided from the volume of the receiving chamber of the ultrafiltration device (filter) with the connection to the contact tank.

As a result, a second recirculation line is formed according to the following arrangement: output from the filter receiving chamber—entrance to the contact tank, and then through the contact tank to the ejector at the filter inlet. Additionally, in some cases, (in the technologically predetermined places), it is advisable to install a trap for organic oxidation products and/or drains on this line.

In particular, it is advisable to do this in the case of small volumes of the receiving chamber of the ultrafiltration device. All lines in the technological arrangement, such as inputs and outputs to the appropriate devices are equipped with shut-off and control valves.

The approximate conditions for the filtration utilizing ultra-membranes are as follows: differential pressure 0.05-0.6 MPa, ozonated air mixture flow rate through the ejector 0.3-30 m³/hour, dissolved ozone content in water 0.01-1.0 g/m3, and the degree of water purification up to 92%.

It is known that in the alkaline environment, the oxidation of organic impurities occurs more completely. Therefore, it is advisable to create an alkaline environment in the receiving chamber. To do so, catholyte from an external electrolyzer can be introduced into the receiving chamber of the ultrafiltration device to create an environment with a pH in the range between 8.0 and 11.0.

A serious problem with the efficiency of filtration in the ultrafiltration device is contamination of the surface of the ultrafiltration membranes with viscous oxidation products of organic matter. It is known that such products are predominantly colloidal formations. These products stick to the surface of the membranes and clog the pores preventing the filtration process.

It is known from practice that sticking of viscous products to the membranes is prevented by the formation of a high-speed and/or turbulent regime of liquid movement in the receiving chamber of the filter. This is due to the mechanical knocking of these products by the liquid flow.

This process is significantly enhanced in the case of a special organization of bubble mode in these liquid flows, i.e. creating a significant number of bubbles in the flow of filtered water or formation a water-bubble flow. Moreover, the formation of such a regime is necessary primarily in the near-membrane spaces, i.e. in the spaces adjacent to the membrane surface.

As a result, a gas-liquid flow is formed, wherein the gas is in the form of a large number of bubbles knocking down viscous adhesion on the membrane surface, while such surface simultaneously being exposed to a high-speed water flow.

The effectiveness of cleaning membranes from the adhesion of viscous organic oxidation products due to knocking them down when a water-bubble flow flows over the membrane surface has been proven in practice. Such an effective bubble mode for knocking down viscous organic oxidation products from the surface of ultrafiltration membranes is achieved when using a water-jet ejector with the following characteristics:

The water flow rate through the water jet ejector is from 0.5 to 45 m³/hour, the flow rate of the ozonated air or ozone-oxygen mixture is from 0.3 to 30/m³/hour, the ratio of the diameter of the suction flow nozzle to the diameter of the water flow injection nozzle is from 0.35 to 1.0, the pressure in the ejector discharge line is varied in the range from 0.2 to 1.6 MPa, the vacuum in the receiving chamber of the water jet ejector relative to atmospheric pressure is in the range from 0.03 to 0.098 MPa.

An even greater increase in cleaning efficiency can be achieved by using multiple ejectors located at the optimal locations. Such places, for example, are the location between tubular membranes or the direction corresponding to the flow around the surface of the membrane.

Effective flow of the water-bubble stream around the surface of the membranes is achieved by the optimal location of the ejector, as well as by the additional implementation of separators and flow guides, which direct the water-bubble flow directly to the surface of the membranes, while regulating the flow rate.

The efficiency of cleaning the surface of membranes is also increased by the use of ceramic materials based on oxides. For example, materials for their production can be based on silicon and titanium oxides.

This can be explained by the low physicochemical affinity of organic oxidation products for these oxides, which is known from the practice of using ceramic ultrafiltration membranes.

The contact tank is typically a chamber with inputs for source water and an ejector, as well as a second recycling line. The tank is also formed with an outlet to the pipeline directed to the ultrafiltration device.

The ultrafiltration device is a container, substantially cylindrical in shape having tubular membranes made of titanium and silicon oxides placed within an interior part thereof. The pore size of the membranes ranges from 0.001 to 0.1 microns.

The total filtering surface of the membranes ranges from 0.15 to 2 m² for one tubular membrane or up to 24 m² for the entire device, which is often made with 12 membranes.

The interior of the filtration device container is formed with partitions, which together with membranes divide its inner space into a receiving chamber and a filtration compartment. The container inner space is provided with inlets for placing an ejector and two outlets for connecting the second recycling pipeline and the filtrate outlet pipeline. If more than one ejector is used, then a corresponding number of inputs are made in the container. These structures and structural elements can be made of stainless steel and polymers, as well as composite materials.

The essential and novel features of the invention with respect to the best known prior art are:
supplying water to the ultrafiltration device simultaneously with supplying ozonated air or ozone-oxygen mixture through at least one water-jet ejector,
formation of a second recirculation cycle utilizing the ultrafiltration device and the contact tank,
implementation of a high-speed and/or turbulent gas-liquid regime in the near-membrane space/surface with a water-bubble flow flowing around the surface of the membrane, when implementing the following gas-liquid regimes/characteristics:
the water consumption through the water jet ejector ranges from 0.5 to 45 m3/hour,
the consumption of ozonated air or ozone-oxygen mixture ranges from 0.3 to 30 m3/hour,
the pressure in the receiving chamber of the water-jet ejector is in the range from 0.2 to 1.6 MPa.

The provided essential features of the invention are distinctive from the closest closes prior art known to the inventor, etc. each of them is not contained in the totality of essential features of the prototype, i.e. is not present in the list of features implemented in the prototype and is not their characteristic.

As has already been shown above, the indicated essential features distinguishing from the prototype, including their characteristics, ensure the achievement of the declared technical result when using other essential features of the invention specified in the description.

Thus, it is shown that the set of essential features of the claimed invention, which makes it possible to achieve the declared technical result, differs from the set of essential features of analogues, a prototype, as well as other known sources of data, i.e. the use of this set of essential features to obtain the stated technical result is not known. In other words, the claimed invention is not known from the prior art.

In the course of studying the state of the art of methods for purifying water with organic impurities by ultrafiltration, as well as devices for its implementation, no technical solutions were identified, the essential features of which, individually or in any combination, coincide with the distinctive essential features of the claimed invention and make it possible to achieve the claimed technical result.

Thus, the lack of knowledge of the influence of the distinctive essential features of the claimed invention on the claimed technical result has been confirmed.

It should also be noted that the use of the entire declared set of essential features, including the set of distinctive features, to obtain the declared technical result is not obvious to specialists from the prior art, since it does not constitute a combination, modification or sharing of the information contained in the level of technology, and/or general knowledge of a specialist.

Indeed, reducing the degree of contamination of the surface of ultrafiltration membranes with oxidation products of organic impurities due to the knocking of these products from the surface of ultrafiltration membranes with a water-bubble flow, which in turn leads to an increase in the efficiency of water purification and a reduction in the number of measures for cleaning the membranes, does not follow explicitly from experts prior art through the use of the above distinctive essential features.

The technical solutions presented are, in relation to the confirmed achievement of the stated technical result, non-standard and unknown solutions. In addition, these solutions or these sets of essential features should be considered along with the use of other essential features claimed in the claims in a single set.

Increasing the efficiency of the technical result of the invented method is achieved in the following modifications of the method, which characterize special cases of its implementation:
1. The above-described method of purifying water containing organic impurities by ultrafiltration, characterized in that an alkaline environment is created in the receiving chamber of the ultrafiltration device having the pH range from 8.0 to 11.0 by introducing catholyte from an external electrolyzer.
2. The method described above for purifying water containing organic impurities by ultrafiltration, characterized in that filtration in an ultrafiltration device is carried out by means of ultrafiltration membranes made of a mixture of oxide materials based on titanium oxide and silicon oxide.
3. The above-described method of purifying water containing organic impurities by ultrafiltration, characterized in that the pressure in the receiving chamber of the water-jet ejector is in the range from 0.03 to 0.098 MPa.

The method described above for purifying water with organic impurities by ultrafiltration involves the implementation of a device, the design elements of which were described above when describing this method, namely: a device for purifying water containing organic impurities by ultrafiltration, including an ozonation device, a contact tank, a recycling line and the ultrafiltration device itself.

Further, the device includes an additional recycling line from the ultrafiltration device with return through the contact tank, and an additional ozonation device(s) at the inlet to the ultrafiltration device in the form of at least one water-jet ejector; in the water-jet ejector the working diameter of the suction nozzle(s) is related to the working diameter of the nozzle discharge line(s) in the range from 0.35 to 1.0. These nozzles provide the ability to carry out a flow rate of ozonated air or ozone-oxygen mixture for each ejector in the range from 0.3 to 30 m3/hour and a water flow rate in the range from 0.5 to 45 m³/hour. The above makes it possible to create a water-bubble flow in the receiving chamber of the filter effectively enveloping the surface of the membranes.

Increase in the efficiency of the technical result of the device of the invention is achieved in the following modifications of the method, which characterized special cases of its implementation:

1. The above-discussed device for purifying water containing organic impurities using the ultrafiltration method, characterized in that a catholyte supply line directed from an external electrolyzer is provided/installed into the receiving chamber of the ultrafiltration device to create an alkaline environment in the filtered water.
2. The above-described device for purifying water containing organic impurities using the ultrafiltration method, characterized in that the ultrafiltration membranes in the ultrafiltration device are made from a mixture of oxide materials based on titanium and silicon oxides.

### BRIEF DESCRIPTION OF DRAWINGS

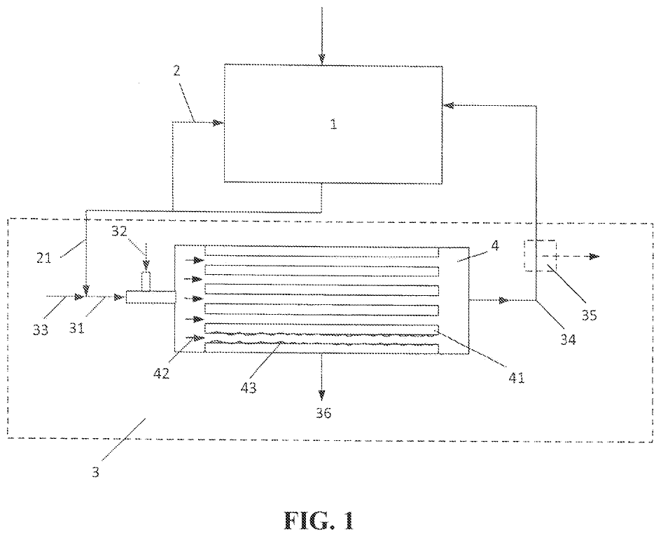

The description of the method, apparatus and system of the invention is illustrated by the diagram of FIG. 1 with the following designations of its processes:
1—disinfection of the source water by ozonation in a contact container,
2—mixing by recirculation method (primary/initial recirculation),
21—input of the secondary recirculation line,
3—ultrafiltration,
31—water supply through a water-jet ejector,
32—supply of ozone mixture through the ejector,
33—input of additional components,
34—output line of the secondary recirculation,
35—separation of oxidation products of the organic impurities using a special trap,
36—the output/exit of the filtrate line output,
4—ultrafiltration device,
41—ultrafiltration tubular membrane,
42—water-bubble flow, and
43—oxidation products of organic impurities.

### EMBODIMENTS OF THE INVENTION

The present invention—Method for purifying water with organic impurities by ultrafiltration and a device and a system for its implementation are carried out in the following manner.

In general, the implementation of the method of the invention begins with cleaning from coarse impurities in filters or mechanical cleaning devices. After this, the water is directed into a contact container, where it is ozonated 1 in order to oxidize and disinfect the organic impurities, while being simultaneously mixed by recirculation 2 according to the following directives: exit from the container—entrance to the container.

The ozone-treated water is directed to an ultrafiltration device for further purification (ultrafiltration stage) 3. Water is supplied to the ultrafiltration device through a water-jet ejector 31. Simultaneously, an ozonated air or ozone-oxygen mixture 32 is supplied by using the ejector.

In this case, through an additional ejector pipe or other device, it is possible to supply additional components 33. From the receiving chamber of the device, a part of the filtered water is removed into the contact tank. Thus, the second recirculation line 34 is implemented in the following manner: exiting from the filter receiving chamber—entering to the contact tank and then through the contact tank to the ejector at the filter inlet.

In the recirculation line, separation of oxidation products of organic impurities is organized using a special trap 35. From the filtrate compartment of the ultrafiltration device, a filtrate line 36 is extended. Ultrafiltration is carried out using tubular-shaped ceramic membranes 4 with a pore size of 0.01-0.1 microns.

To maintain the effective filtration in the prior-membrane space 41, a specifically directed water-bubble flow 42 is organized, which knocks off the oxidation products of organic impurities 43 from the membrane surfaces.

The approximate conditions for filtration at ultra membranes are as follows: differential pressure 0.05-0.6 MPa, flow rate of the ozone-air mixture through the ejector 0.3-30 m³/hour), dissolved ozone content in water 0.01-1.0 g/m³, degree of water purification up to 92%. The total filtering surface of the membranes ranges from 0.15 to 2 m² (up to 24 m² for the entire ultrafiltration device).

The discussed method and device operate in the following manner.

The water intended for purification is first passed through a mechanical filter and then sent to a contact tank for ozonation. Ozonation is carried out either by bubbling through a layer of water or using a water-jet ejector installed at the entrance to the container.

At the same time, water is mixed in a contact container with the ozone mixture using recycling through an external circuit according to the following scheme: exit from the container—entrance to the container. The water thus ozonized is sent to an ultrafiltration device. At the entrance to this device there is a water-jet ejector, assisting in the additional ozonation of water to be carried out with an ozone-air or ozone-oxygen mixture.

Simultaneously, by regulating the flow of water and gas flows, a high-speed water-bubble stream flows around the surface of the membranes. Such a stream knocks off the viscous oxidation products of organic impurities from the surface of the membranes. A part of the liquid is taken from the receiving chamber to be sent to a contact container, thereby creating a second recycling line.

A trap is installed on this second recycling line to separate oxidation products of organic impurities, which are periodically drained, i.e. removed from the technological chain. The implementation of a water-bubble flow is reviewed based on the visual observation through a special transparent window or reviewed by the composition of the flow through the trap.

Additional components, for example catholyte, can also be introduced into the receiving chamber. The water that has passed through the membrane is collected in the filtrate compartment and discharged through a separate line.

### Example 1

The source water had the following characteristics: iron content 1.5 mg/l, manganese content from 0.3 mg/l, petroleum products 0.1 mg/l, ammonia 2.5 mg/l, permanganate oxidation from 6 mg/l, including presence of traces of chlorine and organochlorine compounds.

Such water was directed into a contact container with a volume of 400 liters, where an ozone-air mixture with an ozone content of 8 mg/l was bubbled through it. From the container, ozonized water was sent to an ultrafiltration device.

At the same time, at the outlet of the container, part of the flow was taken and directed through an external pipeline again to the entrance to the container. Thus, mixing was carried out. The water consumption was 2 m³/hour.

The differential pressure of filtration through the membranes was 0.2 MPa, the filtration surface of the membranes was 2.0 m2. At the outlet of the filter the water had the following characteristics: iron content 0.2 mg/l, manganese content from 0.1 mg/l, petroleum products 0.01 mg/l, ammonia 1.6 mg/l, permanganate oxidation from 4 mg/l, no traces of chlorine and organochlorine compounds was noted.

To maintain constant cleaning parameters, the inlet compartment of the ultrafiltration device and its membranes are cleaned once a week. The vacuum in the receiving chamber of the water-jet ejector relative to atmospheric pressure is in the range from 0.03 to 0.098 MPa.

### Example 2

The source water had characteristics similar to those specified in Example 1. Water purification was also carried out according to the method specified in Example 1. However, in addition to this, a part of the filtered water was discharged from the receiving chamber back to the contact tank through a separate pipeline, implementing a second recycling circuit. Periodically, slimy organic oxidation products were drained from the trap.

In the receiving chamber in the near-membrane layer, a water-bubble flow was carried out, cleaning the surface of the membranes. This was observed by visual observations through a special transparent window. The water-bubble regime was carried out by maintaining the following characteristics:
water consumption was 0.5 m3/hour, ozone-air mixture consumption was 0.3 m3/hour, while the diameter of the suction nozzle was 3 mm, and the diameter of the discharge nozzle was 3 mm, the vacuum in the receiving chamber of the water-jet ejector relative to atmospheric pressure was 0.03 MPa, dissolved ozone content in water 0.01 g/m³, differential filtration pressure through membranes was 0.05 MPa, membrane filtration surface was 0.15 m² (for one tubular membrane).

At the outlet of the filter the water had the following characteristics: iron content 0.01 mg/l, manganese content from 0.01 mg/l, petroleum products 0.01 mg/l, ammonia 0.5 mg/dm³, permanganate oxidation from 1 mg/l, no traces of chlorine and organochlorine compounds were noted.

To maintain constant cleaning parameters, the inlet compartment of the ultrafiltration device and its membranes are cleaned once every 4 months.

### Example 3

The source water had characteristics similar to those specified in Example 1. Water purification was also carried out according to the method specified in Example 1. However, in addition to this, a part of the filtered water was discharged from the receiving chamber back to the contact tank through a separate pipeline, implementing a second recycling circuit.

A trap was installed on this second recycling line to separate oxidation products of organic impurities. Periodically, slimy organic oxidation products were drained from the trap. In the receiving chamber in the near-membrane layer, a water-bubble flow was carried out, cleaning the surface of the membranes, as judged by visual observations through a special transparent window.

The water-bubble mode was carried out by maintaining the following characteristics: water flow was 45 m³/hour, ozone-air mixture flow rate was 30 m3/hour, while the diameter of the suction nozzle was 20 mm, and the diameter of the discharge nozzle was 56 mm, vacuum in the receiving area the chamber of the water-jet ejector relative to atmospheric pressure was 0.098 MPa, the differential filtration pressure through the membranes was 0.6 MPa, the filtration surface of the membranes was 24 m² (for 12 tubular membranes). Water was introduced through a group of 6 ejectors.

At the outlet of the filter the water had the following characteristics: iron content 0.02 mg/l, manganese content from 0.03 mg/l, petroleum products 0.01 mg/l, ammonia 0.6 mg/l, permanganate oxidation from 1.5 mg/l, no traces of chlorine and organochlorine compounds were noted. To maintain constant cleaning parameters, the inlet compartment of the ultrafiltration device and its membranes are cleaned once every 4 months.

### Example 4

The source water had the following characteristics: iron content 15 mg/dm3, manganese content from 1 mg/l, petroleum products 0.5 mg/l, ammonia 7 mg/l, permanganate oxidation from 10 mg/l, the presence of traces of chlorine and organochlorine compounds was noted.

Water purification was also carried out according to the method specified in Example 2. However, in addition to this, a part of the purified water passed through an electrolyzer and catholyte was supplied to the contact tank through a separate pipeline, which increases the pH to 8.5.

In the receiving chamber in the near-membrane layer, a water-bubble flow was carried out, cleaning the surface of the membranes, as reviewed by visual observations through a special transparent window.

The water-bubble mode was carried out by maintaining the following characteristics: water flow was 3 m³/hour, ozone-air mixture flow rate was 1 m3/hour, while the diameter of the suction nozzle was 6 mm, and the diameter of the discharge nozzle was 8 mm, vacuum in the receiving chamber of the water jet ejector relative to atmospheric pressure was 0.05 MPa, the differential filtration pressure through the membranes was 0.2 MPa, the filtration surface of the membranes was 1 m².

At the outlet of the filter the water had the following characteristics: iron content 0.01 mg/l, manganese content from 0.01 mg/l, petroleum products 0.01 mg/l, ammonia 0.3 mg/l, permanganate oxidation from 1.5 mg/l, no traces of chlorine and organochlorine compounds were noted.

To maintain constant cleaning parameters, the inlet compartment of the ultrafiltration device and its membranes are cleaned once every 5 months.

The above examples should not be construed as limiting the scope of the invention. On the contrary, variations, modifications and equivalents of the described examples are also possible within the scope of the rights set forth in the claims.

In this case, the material objects are water and ozone gas mixtures. Actions are carried out on these material objects: water supply, water treatment with ozone, water purification by filtration, flow separation, regulation of the supply and consumption of water and ozone mixtures.

All actions on the specified material objects are performed in time and in a certain sequence. Moreover, the totality of these actions, the essential features of this invention, is technologically and functionally interconnected and united by a single creative concept.

This technical solution is industrially applicable in various areas of the national economy where highly purified water is required, in particular in medicine, in various fields of chemistry, and the food industry.

The implementation of the proposed technical solution can be carried out by specialists with appropriate training. When implementing the method of producing and selling alkaline water, devices, instruments and materials produced by industry and publicly available are used.

Methods for implementing the technological scheme of the invention are methods of mechanical processing of metal and plastics, electric welding and thermal welding of plastics, metalworking, installation.

The means of implementation are mechanical means, machine tools and manual machining tools, welding equipment.

The above set of essential features of the claimed invention allows us to conclude that the claimed technical results have been achieved, which consist of reducing the degree of contamination of the surface of ultrafiltration membranes with oxidation products of organic impurities due to knocking down these products from the surface of ultrafiltration membranes with a water-bubble flow, which leads to increased efficiency water purification and reducing the number of membrane cleaning activities.

In addition, the technical results should also be considered as an expansion of the arsenal of technical means for purifying water with organic impurities by ultrafiltration, as well as devices for its implementation.

The above description of the invention and examples of its implementation confirm the achievement of the technical results in the process of implementing the invention.

1. A method for purifying water with organic impurities by ultrafiltration, comprising the following steps:
a preliminary preparation of water for ultrafiltration by ozonation and mixing by recirculation in a contact container, and ultrafiltration utilizing membranes, wherein forming a first recirculation cycle by means of water being supplied to an ultrafiltration device simultaneously with a supply of ozonated air or ozone-oxygen mixture by utilizing at least one water-jet ejector; forming a second recirculation cycle wherein through the ultrafiltration device liquid/water being directed into a contact container and being recirculating again into the ultrafiltration device; forming a high-speed and/or turbulent gas-liquid regime in a near-membrane space of the ultrafiltration device with a water-bubble flow flowing around a membrane surface, while settling a water flow rate through the at least one water-jet ejector in the range from 0.5 to 45 m³/hour, settling a flow rate of the ozonated air or ozone-oxygen mixture in the range from 0.3 to 30 m³/hour, and settling a pressure at an ejector discharge line in the range from 0.2 to 1.6 MPa.

2. The method according to claim 1, wherein an alkaline environment is formed in a receiving chamber of the ultrafiltration device in the range of from 8.0 to 11.0 pH by means of an introduction of catholyte from an electrolyzer situated externally to the ultrafiltration device.

3. The method according to claim 1, wherein filtration in the ultrafiltration device is carried out utilizing ultrafiltration membranes made of a mixture of oxide materials based on titanium oxide and silicon oxide.

4. The method according to claim 1, wherein a vacuum is formed in a receiving chamber of the at least one water-jet ejector relative to an atmospheric pressure in a range from 0.03 to 0.098 MPa.

5. A device for purifying water containing organic impurities by an ultrafiltration method, comprising:
an ozonation device, a contact tank, a recycling line and an ultrafiltration device, further comprising an additional recycling line extending from the ultrafiltration device and returning through the contact tank, and at least one said ozonation device being provided at an inlet to the ultrafiltration device in the form of as at least one water-jet ejector, wherein a working diameter of a suction nozzle of the at least one water-jet ejector relates to a working diameter of a discharge line nozzle is in a range from 035 to 1.0, wherein said nozzles form a flow ozonated air or ozone-oxygen mixture for each said at least one water-jet ejector in a range from 0.3 to 30 m³ hour and a water flow in a range from 0.5 to 45 m³/hour; wherein a water-bubble flow is formed in a receiving chamber of the ultrafiltration device to envelope surfaces of the membranes.

6. The device according to claim 5, wherein a catholyte supply line is made into the receiving chamber of the ultrafiltration device from an external electrolyzer to create an alkaline environment in the filtered water.

7. The device according to claim 5, wherein the ultrafiltration membranes in the ultrafiltration device are made from a mixture of oxide materials based on titanium and silicon oxides.
